(19) United States
(12) Patent Application Publication
(10) Pub. No.: US 2025/0030330 A1
(43) Pub. Date: Jan. 23, 2025

(54) CHAIN-LINK CONVERTER

(71) Applicant: Delta Electronics (Shanghai) Co.,Ltd., Shanghai (CN)

(72) Inventors: Peng XIAO, Shanghai (CN); Ming WANG, Shanghai (CN); Teng LIU, Shanghai (CN); Jianxing DONG, Shanghai (CN); Jianfei ZHENG, Shanghai (CN)

(21) Appl. No.: 18/774,955

(22) Filed: Jul. 17, 2024

(30) Foreign Application Priority Data
Jul. 18, 2023 (CN) 202310886017.0
Jan. 17, 2024 (CN) 202410071446.7

(51) Int. Cl. H02M 1/00; H02M 1/14; H02M 3/335

(52) U.S. Cl. CPC H02M 1/007; H02M 1/143; H02M 3/33569

(57) ABSTRACT

The disclosure provides a chain-link converter, comprising: a first node; a second node; and a plurality of switch submodules, wherein the plurality of switch submodules are connected in series, and the plurality of switch submodules are electrically connected between the first node and the second node, and a switching time of at least one switch submodule is greater than the switching time of other switch submodules. The chain-link converter of the disclosure effectively suppresses the common-mode current by extending the switching time of at least one switch submodule.

### CROSS-REFERENCE TO RELATED APPLICATIONS

This non-provisional application claims priority under 35 U.S.C. § 119(a) on Patent Applications No. 202310886017.0 filed on Jul. 18, 2023, in P.R. China and No. 202410071446.7 filed on Jan. 17, 2024, in P.R. China, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### TECHNOLOGY FIELD

The disclosure relates to the technical field of energy storage system, and particularly to a chain-link converter.

### BACKGROUND

The chain-link converter is formed of a plurality of submodules connected in series, and since batteries of the chain-link energy storage system have a large volume, a distributed capacitance of the batteries to ground is large, and a large common-mode current will be produced. However, the common-mode current affects EMI, increases system loss, and must be processed to ensure that the system runs normally. Meanwhile, a common-mode voltage causes damage to core insulation through the common-mode current flowing through the distributed capacitance between the batteries and ground. Moreover, criteria such as VDE 4105 also have a strict requirement for the common-mode current of the photovoltaic system, and it is required that earth leakage currents must be under the criteria when involving the issues of personal safety and fire and the issue of EMI. That is, it is required that a photovoltaic contact leakage current is 30 mA or less, and a fire leakage current is 300 mA or less.

### SUMMARY

With respect to deficiencies of the prior art, the disclosure provides a chain-link converter, which can effectively reduce a common-mode current.

In order to achieve the object, the disclosure provides a chain-link converter, comprising:
a first node;
a second node;
a plurality of switch submodules, wherein the plurality of switch submodules are connected in series, and the plurality of switch submodules are electrically connected between the first node and the second node, and a switching time of at least one switch submodule is greater than the switching time of other switch submodules.

Alternatively, the switching time of at least one switch submodule is greater than twice of the switching time of other switch submodules.

Alternatively, the plurality of switch submodules comprise a plurality of low-frequency submodules and a first high-frequency submodule.

Alternatively, a ground terminal is electrically connected to the second node, and one of the low-frequency submodules is electrically connected to the second node.

Alternatively, the first high-frequency submodule is electrically connected to the first node.

Alternatively, a distributed capacitance to ground of any of the low-frequency submodules is greater than the distributed capacitance to ground of the first high-frequency submodule.

Alternatively, a ground terminal is electrically connected between the two adjacent low-frequency submodules.

Alternatively, the first high-frequency submodule is electrically connected to the first node or the second node.

Alternatively, the chain-link converter further comprising:
a second high-frequency submodule, the first high-frequency submodule is electrically connected to the first node, and the second high-frequency submodule is electrically connected to the second node.

Alternatively, phases of a first port voltage of the first high-frequency submodule and a second port voltage of the second high-frequency submodule differ by 180°, such that common-mode currents of the first high-frequency submodule and the second high-frequency submodule flowing the plurality of low-frequency submodules cancel each other.

Alternatively, the first high-frequency submodule and the second high-frequency submodule use a two-level topology or a three-level topology.

Alternatively, the first high-frequency submodule comprises a first full bridge circuit comprising a first bridge arm and a second bridge arm connected in parallel, the first bridge arm comprises a first switch and a second switch connected in series, the second bridge arm comprises a third switch and a fourth switch connected in series, the first central point of the first bridge arm is a first jump point, the second central point of the second bridge arm is a second jump point, and a first port voltage is provided between the first jump point and the second jump point;
the second high-frequency submodule comprises a second full bridge circuit comprising a third bridge arm and a fourth bridge arm connected in parallel, the third bridge arm comprises a fifth switch and a sixth switch connected in series, the fourth bridge arm comprises a seventh switch and an eighth switch connected in series, the third central point of the third bridge arm is a third jump point, the fourth central point of the fourth bridge arm is a fourth jump point, and the second port voltage is provided between the third jump point and the fourth jump point.

Alternatively, when the first switch and the fourth switch are turned on, the first full bridge circuit is in a first mode; when the first switch and the third switch are turned on, the first full bridge circuit is in a second mode; when the second switch and the third switch are turned on, the first full bridge circuit is in a third mode; when the second switch and the fourth switch are turned on, the first full bridge circuit is in a fourth mode;
when the fifth switch and the eighth switch are turned on, the second full bridge circuit is in the first mode; when the fifth switch and the seventh switch are turned on, the second full bridge circuit is in the second mode; when the sixth switch and the seventh switch are turned on, the second full bridge circuit is in the third mode; when the sixth switch and the eighth switch are turned on, the second full bridge circuit is in the fourth mode.

Alternatively, when the first full bridge circuit is switched from the fourth mode to the first mode, the potential at the first jump point becomes high, and when the second full bridge circuit is switched from the first mode to the second mode, the potential at the fourth jump point becomes high;
when the first full bridge circuit is switched from the first mode to the second mode, the potential at the second jump point becomes high, and when the second full bridge circuit is switched from the fourth mode to the first mode, the potential at the third jump point becomes high;
when the first full bridge circuit is switched from the second mode to the third mode, the potential at the first jump point becomes low, and when the second full bridge circuit is switched from the third mode to the fourth mode, the potential at the fourth jump point becomes low;
when the first full bridge circuit is switched from the third mode to the fourth mode, the potential at the second jump point becomes low, and when the second full bridge circuit is switched from the second mode to the third mode, the potential at the third jump point becomes low.

Alternatively, the first high-frequency submodule comprises a first full bridge circuit comprising a first upper bridge arm and a first lower bridge arm connected in series, a first energy storage element and a second energy storage element, the first upper bridge arm comprises a first switch and a second switch connected in series, the first lower bridge arm comprises a third switch and a fourth switch connected in series, and the first central point between the first upper bridge arm and the first lower bridge arm is a first jump point; the first full bridge circuit further comprises a first diode and a second diode connected in series between a first node and a second node, wherein the first node is arranged between the first switch and the second switch of the first upper bridge arm, and the second node is arranged between the third switch and the fourth switch of the first lower bridge arm, and a second central point between the first diode and the second diode is a second jump point; both ends of the first energy storage element and the second energy storage element after series connection are connected in parallel to the first full bridge circuit, and the third node between the first energy storage element and the second energy storage element is connected to the second central point; a first port voltage is provided between the first jump point and the second jump point;
the second high-frequency submodule comprises a second full bridge circuit comprising a second upper bridge arm and a second lower bridge arm connected in series, a third energy storage element and a fourth energy storage element, the second upper bridge arm comprises a fifth switch and a sixth switch connected in series, the second lower bridge arm comprises a seventh switch and an eighth switch connected in series, and the third central point between the second upper bridge arm and the second lower bridge arm is a third jump point; the second full bridge circuit further comprises a third diode and a fourth diode connected in series between a fourth node and a fifth node, wherein the fourth node is arranged between the fifth switch and the sixth switch of the second upper bridge arm, and the fifth node is arranged between the seventh switch and the eighth switch of the second lower bridge arm, and a fourth central point between the third diode and the fourth diode is a fourth jump point; both ends of the third energy storage element and the fourth energy storage element after series connection are connected in parallel to the second full bridge circuit, and the sixth node between the third energy storage element and the fourth energy storage element is connected to the fourth central point; the third jump point and the fourth jump point have the second port voltage therebetween.

Alternatively, the switching time of at least one low-frequency submodule is greater than the switching time of other low-frequency submodules.

Alternatively, the chain-link converter further comprising a power source or a load electrically connected between the first node and the second node.

Alternatively, the power source is a DC power source or an AC power source, the first high-frequency submodule comprises a first switch circuit and a first energy storage element connected in parallel, and the low-frequency submodules comprise a second switch circuit and a second energy storage element connected in parallel.

Alternatively, the first switch circuit comprises a half-bridge inverter circuit or full bridge circuit.

Alternatively, when the power source is the DC power source, the second switch circuit comprises a half-bridge circuit or full bridge circuit.

Alternatively, when the power source is the AC power source, the second switch circuit comprises a full bridge circuit.

The disclosure further provides a three-phase chain-link converter, comprising:
a three-phase source;
a high-frequency submodule; and
a plurality of low-frequency submodules, wherein each phase of the three-phase chain-link converter comprises the plurality of low-frequency submodules connected in series, three phases of the three-phase chain-link converter share the same high-frequency submodule, and a switching time of at least one low-frequency submodule is greater than the switching time of other low-frequency submodules.

Alternatively, the high-frequency submodule comprises a two-level topology or a three-level topology.

Alternatively, the low-frequency submodules comprise a full bridge circuit and energy storage elements connected in parallel.

As can be known from the above schemes, the advantages of the disclosure lie in that:
the chain-link converter provided in the disclosure effectively reduces the common-mode current by extending the switch time of a part of the switch submodules, or lowering the frequencies of the switch submodules.

### BRIEF DESCRIPTION OF THE DRAWINGS

In order to clearly explain the technical solution in the embodiments of the disclosure, hereinafter the drawings used in the embodiments are simply introduced, and obviously, the drawings in the below description are only some embodiments of the disclosure. For those of ordinary skill in the art, other accompanying drawings can be obtained according to these accompanying drawings without creative effort.

FIG. 1 is a topological diagram of a circuit of the chain-link converter in the prior art.

FIG. 2 is a topological diagram of a circuit of the chain-link converter in embodiment one.

FIG. 3A shows a simulation effect diagram when the switch time is 20 ns.

FIG. 3B shows a simulation effect diagram when the switch time is 200 ns.

FIG. 4 is a topological diagram of a circuit of the chain-link converter in embodiment two.

FIG. 5A is a simulation effect diagram of a 2.5 KHZ high-frequency working state.

FIG. 5B is a simulation effect diagram of a 25 HZ low-frequency working state.

FIG. 6 is a topological diagram of a circuit of the chain-link converter in embodiment three.

FIG. 7 is a topological diagram of a circuit of the chain-link converter in embodiment four.

FIG. 8 is a path diagram of a common-mode current of the chain-link converter shown in the embodiment four.

FIG. 9A shows a simulation effect diagram of the embodiment three.

FIG. 9B shows a simulation effect diagram of the embodiment four.

FIG. 10 shows a topological diagram of a circuit of the chain-link converter in embodiment five.

FIG. 11 shows a topological diagram of a circuit of the chain-link converter in embodiment six.

FIG. 12A is another simulation effect diagram of the chain-link converter in the embodiment four.

FIG. 12B is a simulation effect diagram of the chain-link converter in the embodiment six.

FIG. 13 is a topological diagram of a circuit of the chain-link converter in embodiment seven.

FIG. 14 is a topological diagram of a circuit of the chain-link converter shown in embodiment eight.

FIG. 15A is a path diagram of the first exemplary common-mode current of the chain-link converter shown in the embodiment eight.

FIG. 15B is a path diagram of the second exemplary common-mode current of the chain-link converter shown in the embodiment eight.

FIG. 16 is a topological diagram of a circuit of the chain-link converter in embodiment nine.

FIG. 17 is a topological diagram of a circuit of the chain-link converter in embodiment ten.

FIG. 18 is a topological diagram of a circuit of the chain-link converter in embodiment eleven.

FIG. 19 is a topological diagram of a circuit of the chain-link converter in embodiment twelve.

### DETAILED DESCRIPTION

“First”, “second” and the like used in the application do not particularly refer to an order or rank, instead of limiting the disclosure, and are only to distinguish elements or operations described using the same technical term. Secondly, words “include” “comprise”, “have” and “contain” used in the application are all open phrases, and mean including but not limited. In addition, “couple” or “electrical connect” used in the application can refer to that two or more elements are in direct physical contact or electrical contact, or in indirect physical contact or electrical contact. Moreover, in the application, unless otherwise specified to the articles in the context, “a/an” and “the” can generally refer to one or more.

As stated previously, in the prior art, although the modulation method can effectively reduce an effective value of the common-mode voltage to ground, it does not involve adjustment to the number of switching and the switch time, and cannot eliminate a peak value of the common-mode currents due to inconsistency of transient states of the switches.

On such basis, the disclosure adopts schemes such as extending the switching time of the chain-link converter, lowering frequencies of the submodules or optimizing ground points to effectively suppress the common-mode current.

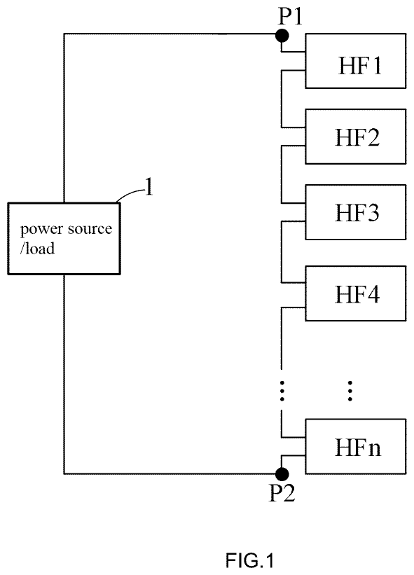

FIG. 1 shows a topological diagram of a circuit of the conventional chain-link converter in the prior art. The chain-link converter comprises a power source or a load 1, a first node P1, a second node P2, and a plurality of high-frequency submodules HFi (wherein i is 1, . . . , and N) connected in series and electrically connected between the first node P1 and the second node P2.

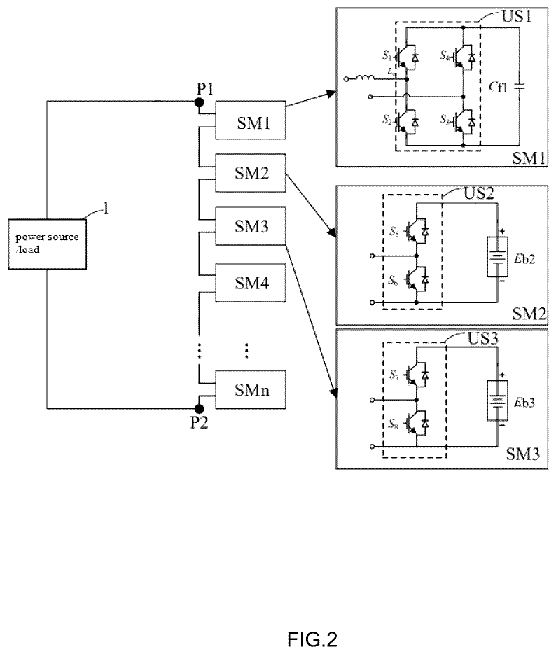

FIG. 2 shows a topological diagram of a circuit of the chain-link converter in embodiment one of the disclosure. The chain-link converter comprises a power source or a load 1, a first node P1, a second node P2, and a plurality of switch submodules SMi (wherein i is 1, . . . , and N) connected in series and electrically connected between the first node P1 and the second node P2. As shown in FIG. 2, each switch submodule Smi comprises a switch circuit Usi (wherein i is 1, . . . , and n) and energy storage elements connected in parallel, the switch circuit Usi can be a half-bridge circuit or full bridge circuit, and the energy storage elements comprise capacitors or batteries. In this embodiment, a switching time of at least one switch submodule is greater than the switching time of other switch submodules, and the switching time refers to a time desired by switching from an “on” state to an “off” state or switching from an “off” state to an “on” state, and since the plurality of switch submodules are a series structure, a du/dt value of the whole series branch can be reduced by increasing the switching time of the at least one switch submodule, thereby reducing a peak value of the common-mode currents.

In some embodiments, the switching time of at least one switch submodule is greater than twice of the switching time of other switch submodules.

In some embodiments, considering of a deviation of circuit devices themselves, such as, a deviation of driving, and a deviation of circuit parameters, the switching time of at least one switch submodule is three or more times of the switching time of other switch submodules.

In some embodiments, when the switch submodules are applied to small power scenarios, and the switch devices are MOSFETs, the switching time is in a nanosecond level, and when the switch submodules are applied to large power scenarios, the switching time is in a microsecond level.

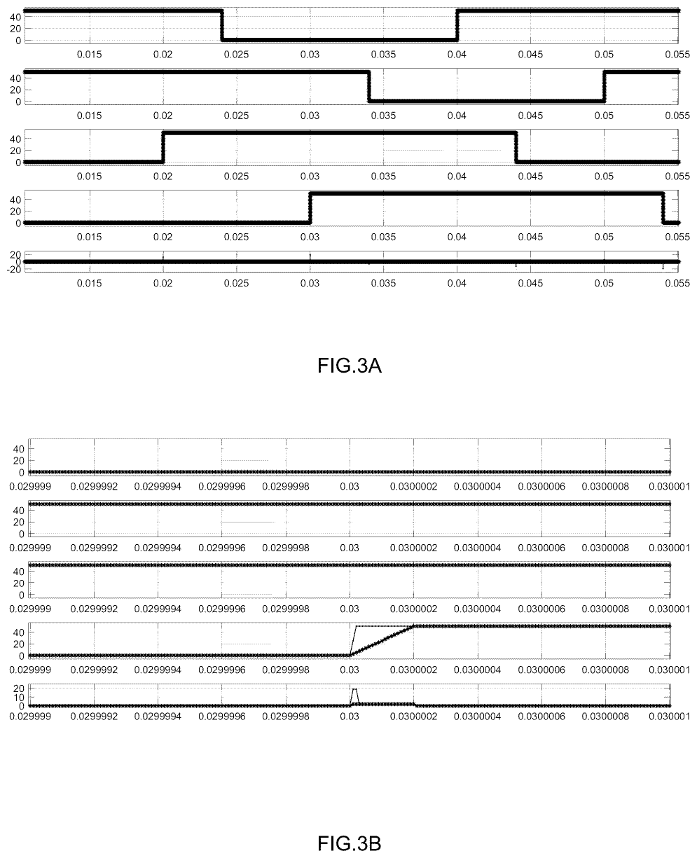

FIGS. 3A, 3B, 5A, 5B, 9A, 9B, 12A and 12B are all simulation effect diagrams where the switch devices are MOSFETs.

FIGS. 3A and 3B show simulation effect diagrams of different switching time s of the chain-link converter in the embodiment one, respectively, wherein FIG. 3A is a simulation effect diagram when the switching time is 20 ns, and shows waveforms of output voltages and common-mode currents of four different switch submodules sequentially from up to down, and FIG. 3B shows a simulation effect diagram when the switching time is extended to 200 ns, and shows waveforms of output voltages and common-mode currents of the four corresponding different switch submodules sequentially from up to down. As can be found from comparison, when the switching time is increased from 20 ns to 200 ns, a peak value of the common-mode currents is reduced from 18 A to 2 A. Therefore, the peak value of the common-mode currents is effectively reduced by extending the switching time of a part of the switch submodules.

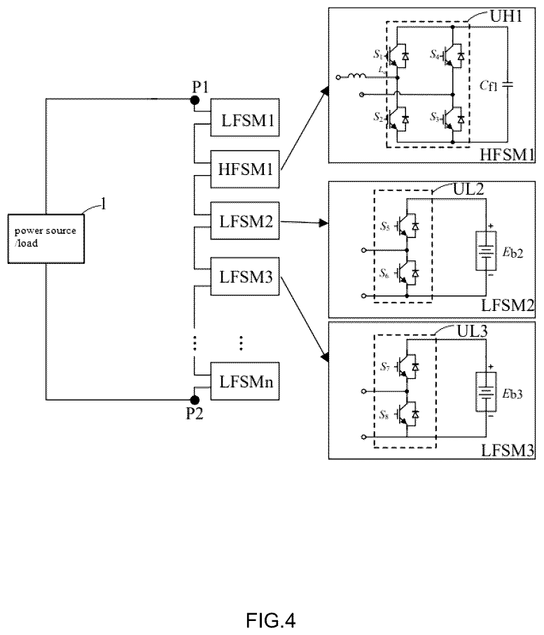

Since the traditional chain-link converters are high-frequency submodules, a volume of the batteries is huge, while a distributed capacitance of the batteries to ground is large to produce a large common-mode current, it is quite necessary to lower frequencies of the switch submodules of the traditional chain-link converters. As shown in FIG. 4, FIG. 4 shows a topological diagram of a circuit of the chain-link converter in embodiment two. In this embodiment, the plurality of switch submodules are provided with a plurality of low-frequency submodules LFSMi, and a high-frequency submodule HFSM1 that compensates for a voltage difference between a bus and the low-frequency submodules, and a frequency of the high-frequency submodule is greater than twice of a frequency of the low-frequency submodules. Generally speaking, since the number of jump of a common-mode voltage of the low-frequency submodules to ground is far lower than the number of jump of the common-mode voltage of the high-frequency submodule to ground, after lowering frequencies of the chain-link converter, the number of jump of the common-mode voltage to ground of the series branch in which the whole high-frequency and low-frequency submodules are mixed is greatly decreased, thereby effectively reducing the common-mode current.

Since frequencies of the low-frequency submodules are very low, and a ratio of switching loss is also low, there are conditions of increasing the switching time, so it is also possible to effectively reduce a peak value of the common-mode currents by configuring the switching time of the low-frequency submodules to be greater than the switching time of the high-frequency submodule.

Referring to FIG. 4 again, the power source comprises an AC power source or a DC power source, the high-frequency submodule comprises a first switch circuit UH1 and a first energy storage element connected in parallel, and the low-frequency submodules comprise a second switch circuit ULi (wherein i is 1, . . . , and n) and a second energy storage element connected in parallel.

In some embodiments, when the power source is the AC power source or the DC power source, the first switch circuit UH1 comprises a half-bridge inverter circuit or full bridge circuit, and the first energy storage element comprises a capacitor.

In some embodiments, when the power source is the DC power source, the second switch circuit ULi comprises a half-bridge circuit or full bridge circuit, and the second energy storage element comprises a capacitor or a battery.

In some embodiments, when the power source is the AC power source, the second switch circuit ULi comprises a full bridge circuit, and the second energy storage element comprises a capacitor or a battery.

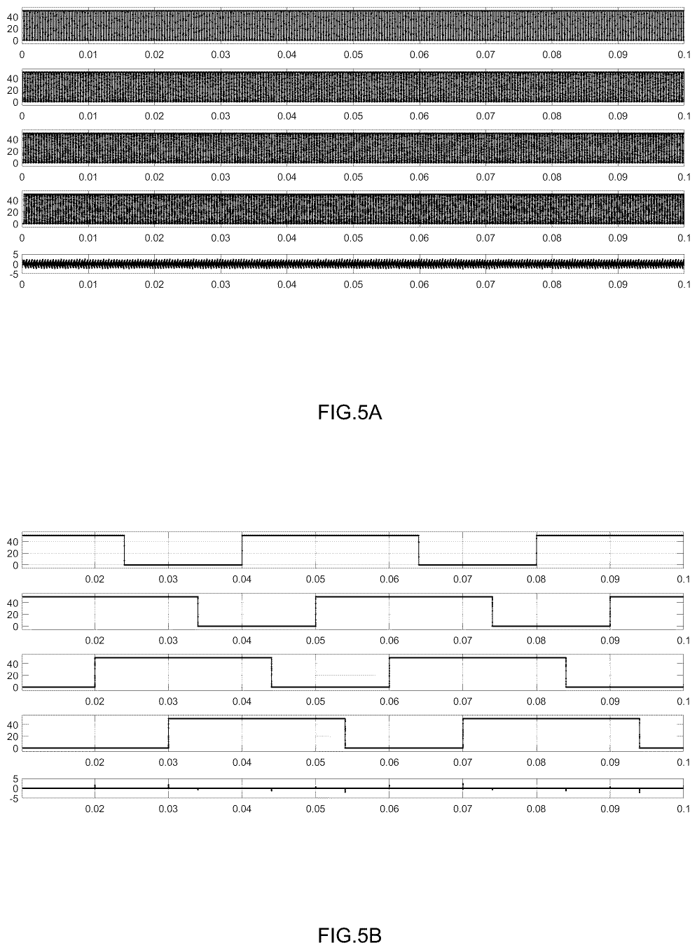

FIGS. 5A and 5B show simulation effect diagrams of the chain-link converter of embodiment one in a high-frequency or low-frequency working state, respectively, wherein FIG. 5A is a simulation effect diagram of the chain-link converter of embodiment one in a 2.5 KHZ high-frequency working state, and shows waveforms of output voltages and common-mode currents of four different switch submodules sequentially from up to down, and FIG. 5B is a simulation effect diagram of the chain-link converter of embodiment one in a 25 KHZ low-frequency working state, and shows waveforms of output voltages and common-mode currents of the four corresponding different submodules sequentially from up to down. As can be known from FIG. 2, as for the same chain-link converter, when in a high-frequency working mode, an instantaneous value of the common-mode current of the submodule to ground is larger, and when in a low-frequency working mode, the instantaneous value of the common-mode current of the submodule to ground is greatly decreased. Therefore, configuring the plurality of submodules to be low-frequency submodules achieves low frequency of the chain-link converter, and also effectively reduces the common-mode current.

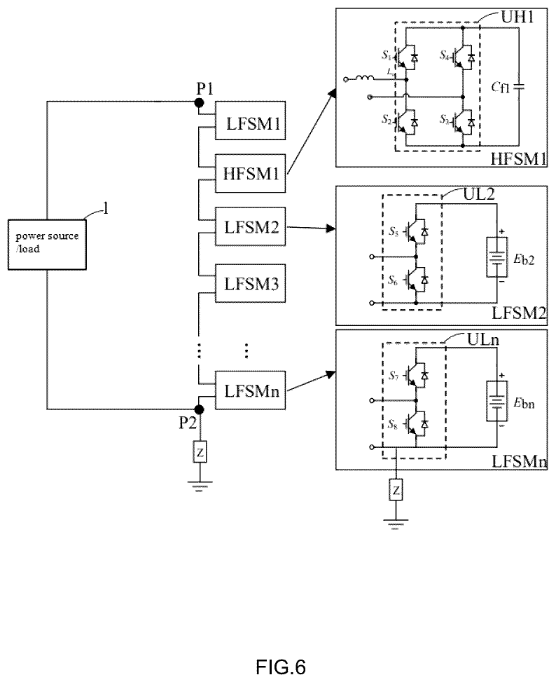

FIG. 6 shows a topological diagram of a circuit of the chain-link converter in embodiment three. In this embodiment, a low-frequency submodule is placed at the second node P2, meanwhile, the second node P2 is grounded through an impedor Z, and the high-frequency submodule is electrically connected to any of the low-frequency submodules, i.e., the high-frequency submodule is placed at a non-ground node. If a place position of the high-frequency submodule is not selected, fast voltage jump of the high-frequency submodule will affect a large number of low-frequency submodules, and in contrast, if the high-frequency submodule is placed away from the ground node, the number of the low-frequency submodules affected by the high-frequency submodule is decreased. Moreover, the farther away from the ground node is, the fewer the number of the low-frequency submodules affected by the high-frequency submodule will be, and the better the suppression effect on the common-mode current will be.

In some embodiments, the switching time of the at least one low-frequency submodule is greater than the switching time of other low-frequency submodules. That is, the switching time of a part of the low-frequency submodules can be extended to suppress the common-mode current, and extending the switching time of the low-frequency submodules at the ground node has better suppression effect on the common-mode current.

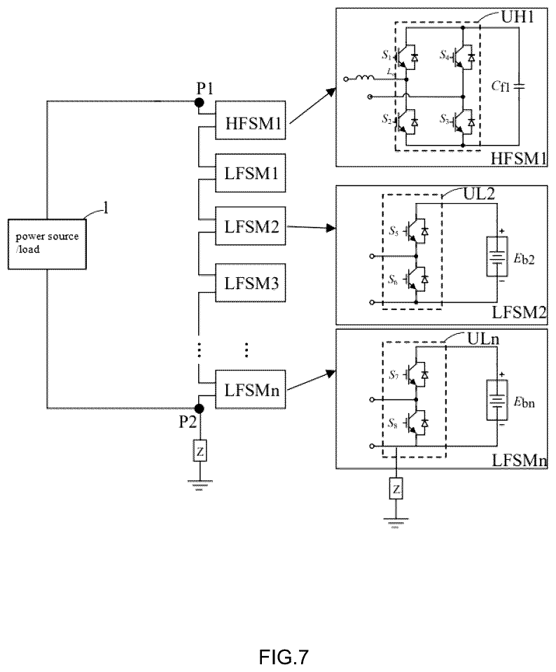

FIG. 7 shows a topological diagram of a circuit of the chain-link converter in embodiment four. As shown in FIG. 7, the high-frequency submodule is placed at the first node P1, and at this time, jump of the common-mode voltage of the high-frequency submodule does not affect the low-frequency submodules. Moreover, since a volume of the high-frequency submodule is much smaller than that of the battery, after pulling apart a distance from the ground node, the distributed capacitance of the high-frequency submodule can be further reduced, and if the distributed capacitance of the high-frequency submodule to ground is sufficient small, it can be considered to be approximately disconnected, and the high-frequency submodule approximately has no influence on the common-mode current generated to ground, so the common-mode current can be better suppressed.

In some embodiments, a distributed capacitance of any of the low-frequency submodules to ground is greater than the distributed capacitance of the high-frequency submodule to ground.

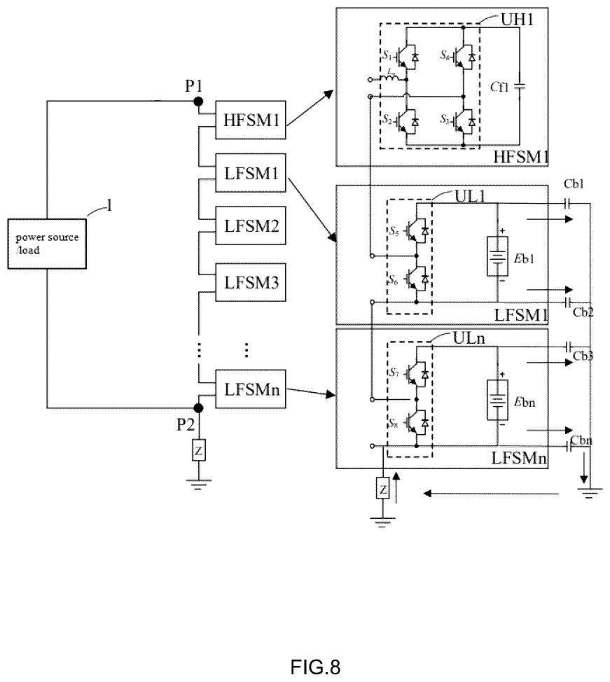

FIG. 8 shows a path diagram of a common-mode current of the chain-link converter in the embodiment four. Assuming that the distributed capacitance of the high-frequency submodule to ground is sufficiently small, it can be ignored, so the common-mode current flows into the ground point through each low-frequency submodule. Therefore, placing the high-frequency submodule at a position away from the ground node reduces influence of the high-frequency submodule on the low-frequency submodules as could as possible, thereby effectively suppressing the common-mode current.

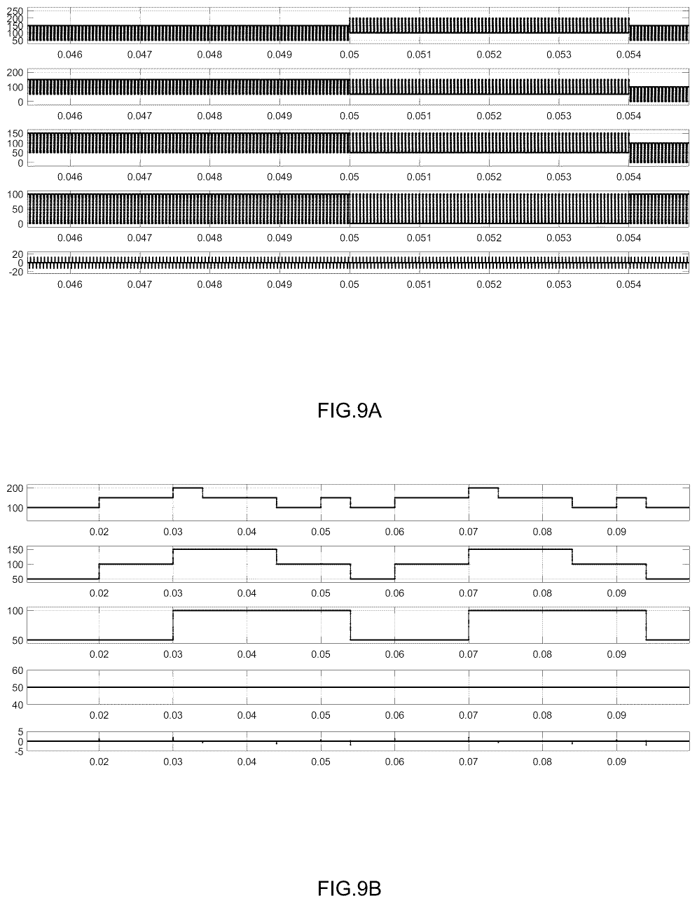

Referring to FIGS. 9A and 9B, FIG. 9A shows a simulation effect diagram of the chain-link converter shown in embodiment three, and shows waveforms of positive ground voltages and instantaneous values of common-mode currents of four different submodules sequentially from up to down, and FIG. 9B shows a simulation effect diagram of the chain-link converter shown in embodiment four, and shows waveforms of positive ground voltages and instantaneous values of common-mode currents of the four different submodules sequentially from up to down. As can be seen from FIGS. 9A and 9B, when the high-frequency submodule is placed at the first node P1, the common-mode current is greatly reduced, and the suppression effect is significant.

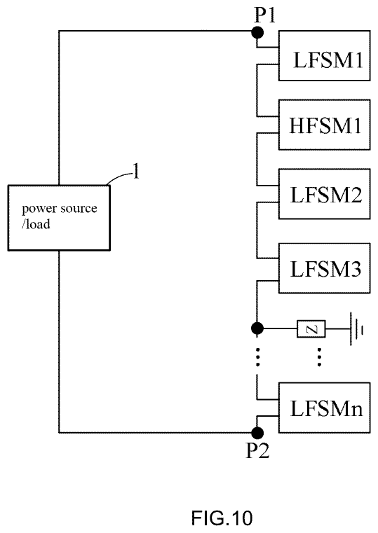

FIG. 10 shows a topological diagram of a circuit of the chain-link converter in embodiment five. In this embodiment, a ground terminal is placed between the two low-frequency submodules, and the high-frequency submodule is electrically connected to any of the low-frequency submodules. In other embodiments, the high-frequency submodule is placed at the first node P1 or the second node P2.

In this embodiment, the ground terminal between the two low-frequency submodules can place the ground terminal at a central point of the low-frequency submodules, and also can place the ground terminal at other positions in addition to the central point of the low-frequency submodules, and the central point of the low-frequency submodules refers to that the numbers of the low-frequency submodules above and below the point are equal. This embodiment can achieve decoupling between voltage jump of the upper and lower parts of the low-frequency submodules of the ground terminal by placing the ground terminal between the two low-frequency submodules, so as to effectively reduce the common-mode current. Meanwhile, when the ground terminal is at the central point or approximate to the central point of the low-frequency submodules, an insulation voltage is lower, and the suppression effect on the common-mode current is better. In other words, the closer the ground terminal to the central point of the low-frequency submodules is, the better the suppression effect on the common-mode current will be.

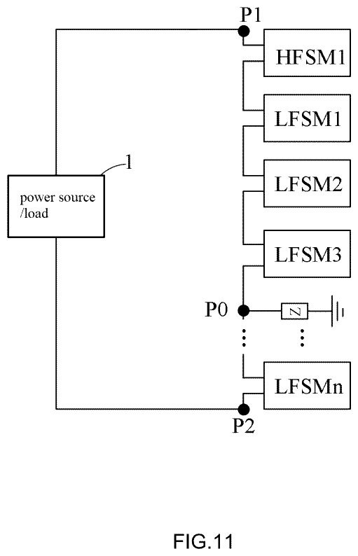

FIG. 11 shows a topological diagram of a circuit of the chain-link converter in embodiment six. As shown in FIG. 11, the series branch has total N+1 submodules, which are N low-frequency submodules and one high-frequency submodule, when N is an even number, and the ground terminal is at a central point P0 of the low-frequency submodules, the maximum number of submodules affected by jump of the common-mode voltage of the low-frequency submodules at the ground node is N/2, which further reduces a peak value of the common-mode current, and also facilitates insulation design of the system.

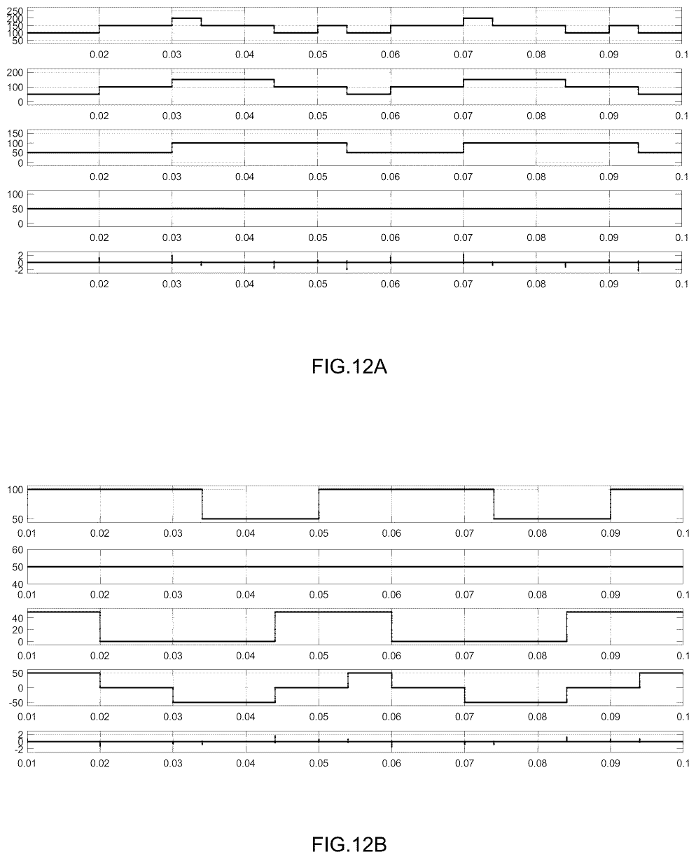

FIGS. 12A and 12B shows simulation effect diagrams of different ground points, respectively, wherein FIG. 12A is another simulation effect diagram of the chain-link converter in the embodiment four, and shows waveforms of positive ground voltages and instantaneous values of common-mode currents of four different submodules sequentially from up to down, and FIG. 12B is a simulation effect diagram of the chain-link converter in the embodiment six, and shows waveforms of positive ground voltages and instantaneous values of common-mode currents of the four different submodules sequentially from up to down. As can be found from comparison, when the ground terminal is at a central point of the low-frequency submodules, since the number of submodules jumped simultaneously is decreased, a peak value of the common-mode current is reduced from 2.2 A to 1.8 A to effectively suppress the common-mode current.

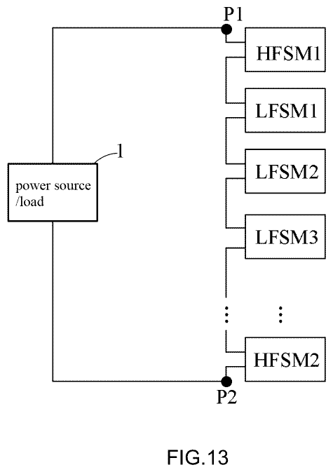

FIG. 13 shows a topological diagram of a circuit of the chain-link converter in embodiment seven. In this embodiment, the chain-link converter comprises a plurality of high-frequency submodules, such as, two high-frequency submodules, i.e., a first high-frequency submodule HFSM1 electrically connected to the first node P1, and a second high-frequency submodule HFSM2 electrically connected to the second node P2. In this embodiment, a redundant setting of the first high-frequency submodule HFSM1 and the second high-frequency submodule HFSM2 allows for replacement of another high-frequency submodule in the case that one high-frequency submodule has fault, while also can effectively reduce the common-mode current.

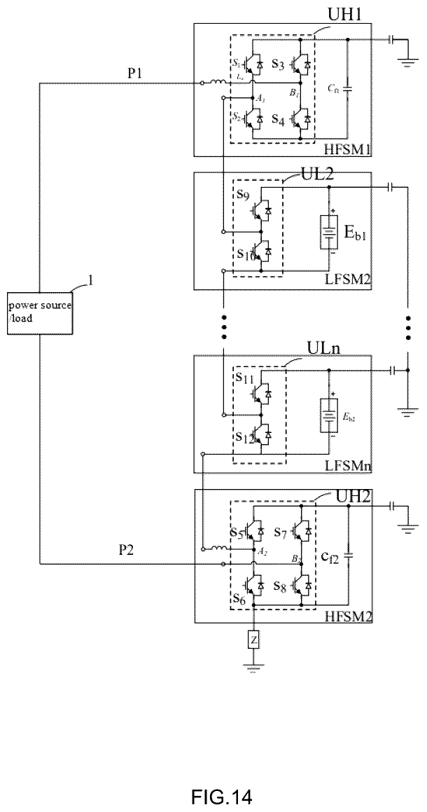

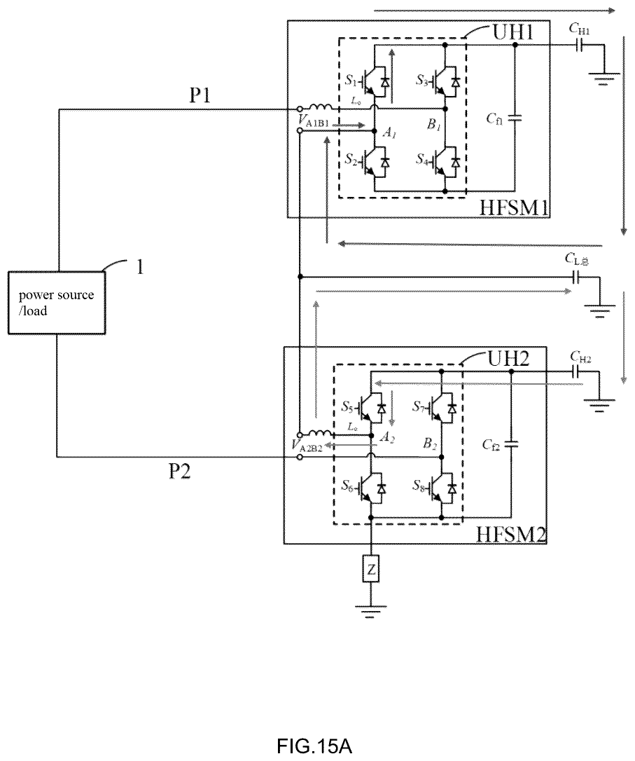

FIG. 14 shows a topological diagram of a circuit of the chain-link converter in embodiment eight, and FIGS. 15A to 15B show path diagrams of several exemplary common-mode currents of the chain-link converter in the embodiment eight, respectively.

In this embodiment, when the common-mode current of the high-frequency submodule cannot be neglected, two high-frequency submodules can be set in the chain-link converter, and influence of the common-mode currents of the high-frequency submodules on paths of the common-mode currents of the low-frequency submodules is eliminated by canceling the common-mode currents of the two high-frequency submodules.

In this embodiment, the chain-link converter comprises a first high-frequency submodule HFSM1, a second high-frequency submodule HFSM2 and a plurality of low-frequency submodules LFSMi (wherein i is 1, . . . , and n). Referring to FIGS. 15A to 15B, considering of influence of the common-mode currents of the high-frequency submodules, all low-frequency submodules are equivalent to be a capacitor CLtotal, i.e., CLtotal is a total parasitic capacitor of all low-frequency submodules to ground. Moreover, CH1 is a parasitic capacitor of the first high-frequency submodule HFSM1 to ground, and CH2 is a parasitic capacitor of the second high-frequency submodule HFSM2 to ground. VA1B1 is a port voltage of the first high-frequency submodule HFSM1, and VA2B2 is a port voltage of the second high-frequency submodule HFSM2.

In this embodiment, working modes of the first high-frequency submodule HFSM1 and the second high-frequency submodule HFSM2 can differ by 180° by controlling switching of respective switches in the first high-frequency submodule HFSM1 and the second high-frequency submodule HFSM2, i.e., phases of the port voltage VA1B1 of the first high-frequency submodule HFSM1 and the port voltage VA2B2 of the second high-frequency submodule HFSM2 differ by 180°, and since structures of the first high-frequency submodule HFSM1 and the second high-frequency submodule HFSM2 are the same, the common-mode currents of the two high-frequency submodules flowing the low-frequency submodules cancel each other, thereby eliminating influence of the common-mode currents of the high-frequency submodules on paths of the common-mode currents of the low-frequency submodules. Moreover, it can be understood that in the disclosure, in a two-level topological circuit or a three-level topological circuit, cancellation of the common-mode currents can be achieved through such way.

More specifically, FIG. 15A shows a path diagram of a first exemplary common-mode current of the chain-link converter shown in embodiment eight. As can be known from FIG. 15A, in the exemplary embodiment, the first high-frequency submodule HFSM1 and the second high-frequency submodule HFSM2, for example, can be disposed at the first node P1 or the second node P2, respectively, and are controlled using a two-level topology, for example. The first high-frequency submodule HFSM1 can comprise a first full bridge circuit UH1 and a first energy storage element Cf1 electrically connected to each other, the first full bridge circuit UH1 can comprise a first bridge arm, which can comprise a first switch S1 and a second switch S2 connected in series, and a second bridge arm, which can comprise a third switch S3 and a fourth switch S4 connected in series, a first central point A1 of the first bridge arm is a first jump point, and a second central point B1 of the second bridge arm is a second jump point. The second high-frequency submodule HFSM2 can comprise a second full bridge circuit UH2 and a second energy storage element Cf2 electrically connected to each other, the second full bridge circuit UH2 can comprise a third bridge arm, which can comprise a fifth switch S5 and a sixth switch S6 connected in series, and a fourth bridge arm, which can comprise a seventh switch S7 and an eighth switch S8 connected in series, a third central point A2 of the third bridge arm is a third jump point, and a fourth central point B2 of the fourth bridge arm is a fourth jump point. Taking the path of the common-mode current shown in FIG. 15A for example, the port voltage VA1B1 can have a first phase by controlling respective switches in the first high-frequency submodule HFSM1, and at this time, the common-mode current of the first high-frequency submodule HFSM1 to ground, for example, flows out of the total parasitic capacitance CLtotal of the plurality of low-frequency submodules (a specific current direction can be shown by an arrow direction around the first high-frequency submodule HFSM1 in FIG. 15A); at this time, the port voltage VA2B2 can have a second phase by controlling respective switches in the second high-frequency submodule HFSM2, the second phase and the first phase differ by 180°, and at this time, the common-mode current of the second high-frequency submodule HFSM2 to ground, for example, flows into (a specific current direction can be shown by an arrow direction around the second high-frequency submodule HFSM2 in FIG. 15A) the total parasitic capacitance CLtotal of the plurality of low-frequency submodules. Since the first high-frequency submodule HFSM1 and the second high-frequency submodule HFSM2 are the same, and phases of the port voltage VA1B1 of the first high-frequency submodule HFSM1 and the port voltage VA2B2 of the second high-frequency submodule HFSM2 differ by 180°, the common-mode currents of the two high-frequency submodules flowing the low-frequency submodules can cancel each other, thereby eliminating influence of the common-mode currents of the high-frequency submodules on paths of the common-mode currents of the low-frequency submodules.

In the embodiment of FIG. 15A, working modes of the first high-frequency submodule HFSM1 and the second high-frequency submodule HFSM2 can be changed by controlling switching of respective switches in the first high-frequency submodule HFSM1 and the second high-frequency submodule HFSM2, i.e., the common-mode currents of the two high-frequency submodules flowing the low-frequency submodules cancel each other through change of a potential at the jump point. To describe conveniently, definitions are made as follows:
when the first switch S1 is turned on, the second switch S2 is turned off, the third switch S3 is turned off, and the fourth switch S4 is turned on, the first full bridge circuit UH1 is in a first mode; when the first switch S1 is turned on, the second switch S2 is turned off, the third switch S3 is turned on, and the fourth switch S4 is turned off, the first full bridge circuit UH1 is in a second mode; when the first switch S1 is turned off, the second switch S2 is turned on, the third switch S3 is turned on, and the fourth switch S4 is turned off, the first full bridge circuit UH1 is in a third mode; when the first switch S1 is turned off, the second switch S2 is turned on, the third switch S3 is turned off, and the fourth switch S4 is turned on, the first full bridge circuit UH1 is in a fourth mode.

When the first full bridge circuit UH1 is switched from the fourth mode to the first mode, potential at the first jump point A1 becomes high; when the first full bridge circuit UH1 is switched from the first mode to the second mode, potential at the second jump point B1 becomes high; when the first full bridge circuit UH1 is switched from the second mode to the third mode, potential at the first jump point A1 becomes low; when the first full bridge circuit UH1 is switched from the third mode to the fourth mode, potential at the second jump point B1 becomes low.

The second high-frequency submodule HFSM2 comprises a second full bridge circuit UH2 and a second energy storage element Cf2 electrically connected to each other, the second full bridge circuit UH2 comprises a third bridge arm comprising a fifth switch S5 and a sixth switch S6 connected in series, and a fourth bridge arm comprising a seventh switch S7 and an eighth switch S8 connected in series, a third central point A2 of the third bridge arm is a third jump point, and a fourth central point B2 of the fourth bridge arm is a fourth jump point. To describe conveniently, definitions are made as follows:
when the fifth switch S5 is turned on, the sixth switch S6 is turned off, the seventh switch S7 is turned off, and the eighth switch S8 is turned on, the second full bridge circuit UH2 is in a first mode; when the fifth switch S5 is turned on, the sixth switch S6 is turned off, the seventh switch S7 is turned on, and the eighth switch S8 is turned off, the second full bridge circuit UH2 is in a second mode; when the fifth switch S5 is turned off, the sixth switch S6 is turned on, the seventh switch S7 is turned on, and the eighth switch S8 is turned off, the second full bridge circuit UH2 is in a third mode; when the fifth switch S5 is turned off, the sixth switch S6 is turned on, the seventh switch S7 is turned off, and the eighth switch S8 is turned on, the second full bridge circuit UH2 is in a fourth mode.

When the second full bridge circuit UH2 is switched from the fourth mode to the first mode, potential at the third jump point A2 becomes high; when the second full bridge circuit UH2 is switched from the first mode to the second mode, potential at the fourth jump point B2 becomes high; when the second full bridge circuit UH2 is switched from the second mode to the third mode, potential at the third jump point A2 becomes low; when the second full bridge circuit UH2 is switched from the third mode to the fourth mode, potential at the fourth jump point B2 becomes low.

In order to allow the common-mode currents of the first high-frequency submodule HFSM1 and the second high-frequency submodule HFSM2 on paths of the common-mode currents flowing the low-frequency submodules to cancel each other, the following control ways can be used:
when the first full bridge circuit UH1 is switched from the fourth mode to the first mode, potential at the first jump point A1 becomes high, and at this time, the second full bridge circuit UH2 is switched from the first mode to the second mode, and potential at the fourth jump point B2 becomes high;
when the first full bridge circuit UH1 is switched from the first mode to the second mode, potential at the second jump point B1 becomes high, and at this time, the second full bridge circuit UH2 is switched from the fourth mode to the first mode, and potential at the third jump point A2 becomes high;
when the first full bridge circuit UH1 is switched from the second mode to the third mode, potential at the first jump point A1 becomes low, and at this time, the second full bridge circuit UH2 is switched from the third mode to the fourth mode, and potential at the fourth jump point B2 becomes low;
when the first full bridge circuit UH1 is switched from the third mode to the fourth mode, potential at the second jump point B1 becomes low, and at this time, the second full bridge circuit UH2 is switched from the second mode to the third mode, and potential at the third jump point A2 becomes low.

As can be known from FIG. 15A, the first high-frequency submodule HFSM1 and the second high-frequency submodule HFSM2 are disposed at the first node P1 and the second node P2, respectively. When potential at the first jump point A1 becomes high, the common-mode current of the first high-frequency submodule HFSM1 to ground flows out of the total parasitic capacitance CLtotal of the plurality of low-frequency submodules, and at this time, potential at the fourth jump point B2 of the second high-frequency submodule HFSM2 is controlled to become high, and the common-mode current of the second high-frequency submodule HFSM2 to ground flows into the total parasitic capacitance CLtotal of the plurality of low-frequency submodules. Since the first high-frequency submodule HFSM1 and the second high-frequency submodule HFSM2 are the same, the common-mode currents of the two high-frequency submodules flowing the low-frequency submodules cancel each other, thereby eliminating influence of the common-mode currents of the high-frequency submodules on paths of the common-mode currents of the low-frequency submodules.

FIG. 15B shows a path diagram of a second exemplary common-mode current of the chain-link converter shown in embodiment eight. As can be known from FIG. 15B, in the exemplary embodiment, structures of the first high-frequency submodule HFSM1 and the second high-frequency submodule HFSM2 are different from that in the embodiment of FIG. 15A, and the differences are that the first high-frequency submodule HFSM1 can comprise a first full bridge circuit UH1, which can comprise an upper bridge arm and a lower bridge arm connected in series, a first energy storage element Cf1 and a second energy storage element Cf2, the upper bridge arm can comprise a first switch S1 and a second switch S2 connected in series, the lower bridge arm can comprise a third switch S3 and a fourth switch S4 connected in series, and a first central point A1 between the upper bridge arm and the lower bridge arm is a first jump point. The first full bridge circuit UH1 further comprises a first diode D1 and a second diode D2 connected in series to a first node between the first switch S1 and the second switch S2 of the upper bridge arm and a second node between the third switch S3 and the fourth switch S4 of the lower bridge arm, and a second central point B1 between the first diode D1 and the second diode D2 is a second jump point. Both ends of the first energy storage element Cf1 and the second energy storage element Cf2 after series connection are connected in parallel to the first full bridge circuit UH1, and a third node between the first energy storage element Cf1 and the second energy storage element Cf2 is connected to the second central point B1. The second high-frequency submodule HFSM2 can comprise a second full bridge circuit UH2, which can comprise an upper bridge arm and a lower bridge arm connected in series, a third energy storage element Cf3 and a fourth energy storage element Cf4, the upper bridge arm can comprise a fifth switch S5 and a sixth switch S6 connected in series, the lower bridge arm can comprise a seventh switch S7 and an eighth switch S8 connected in series, and a third central point A2 between the upper bridge arm and the lower bridge arm is a third jump point. The second full bridge circuit UH2 further comprises a third diode D3 and a fourth diode D4 connected in series to a fourth node between the fifth switch S5 and the sixth switch S6 of the upper bridge arm and a fifth node between the seventh switch S7 and the eighth switch S8 of the lower bridge arm, and a fourth central point B2 between the third diode D3 and the fourth diode D4 is a fourth jump point. Both ends of the third energy storage element Cf3 and the fourth energy storage element Cf4 after series connection are connected in parallel to the second full bridge circuit UH2, and a sixth node between the third energy storage element Cf3 and the fourth energy storage element Cf4 is connected to the fourth central point B2. In the exemplary embodiment, the first high-frequency submodule HFSM1 and the second high-frequency submodule HFSM2 can be controlled using a three-level topology. That is, the port voltage VA1B1 can have a first phase by controlling respective switches in the first high-frequency submodule HFSM1, and at this time, the common-mode current of the first high-frequency submodule HFSM1 to ground, for example, flows out (a specific current direction can be shown by an arrow direction around the first high-frequency submodule HFSM1 in FIG. 15B) of the total parasitic capacitance CL of the plurality of low-frequency submodules; at this time, the port voltage VA2B2 can have a second phase by controlling respective switches in the second high-frequency submodule HFSM2, the second phase and the first phase differ by 180°, and at this time, the common-mode current of the second high-frequency submodule HFSM2 to ground, for example, flows into (a specific current direction can be shown by an arrow direction around the second high-frequency submodule HFSM2 in FIG. 15B) the total parasitic capacitance CL of the plurality of low-frequency submodules. Since the first high-frequency submodule HFSM1 and the second high-frequency submodule HFSM2 are the same, and phases of the port voltage VA1B1 of the first high-frequency submodule HFSM1 and the port voltage VA2B2 of the second high-frequency submodule HFSM2 differ by 180°, the common-mode currents of the two high-frequency submodules flowing the low-frequency submodules can cancel each other, thereby eliminating influence of the common-mode currents of the high-frequency submodules on paths of the common-mode currents of the low-frequency submodules.

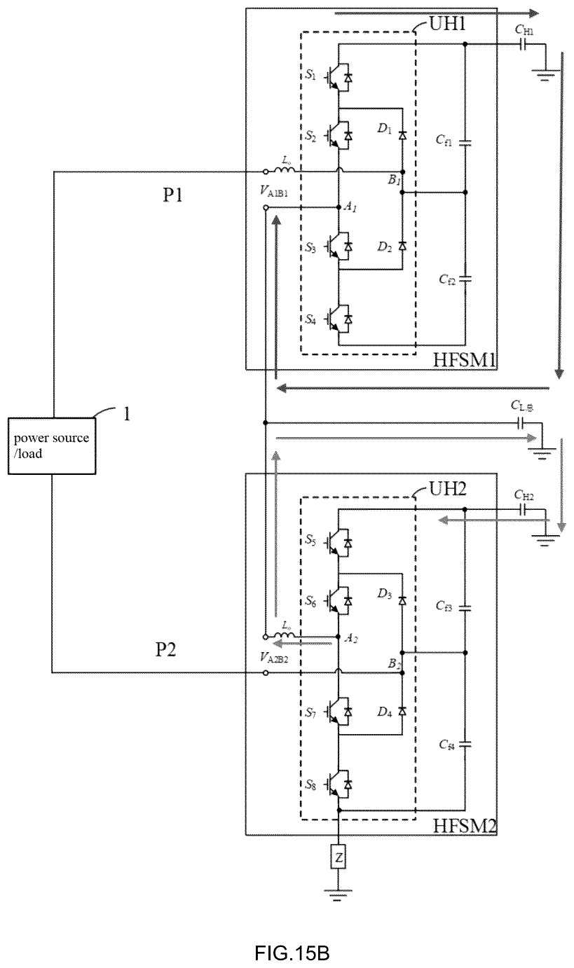

FIG. 16 shows a topological diagram of a circuit of the chain-link converter in embodiment nine. In this embodiment, the power source is an AC power source, the high-frequency submodule HFSM1 comprises a full bridge circuit and a capacitor connected in parallel, and the low-frequency submodules each comprises a full bridge circuit and a battery connected in parallel.

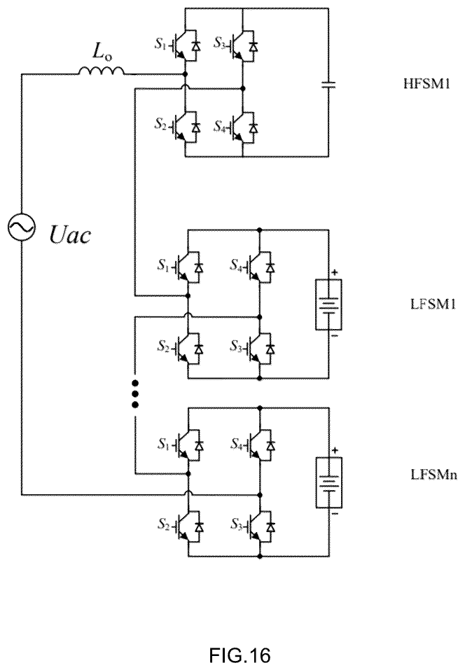

FIG. 17 shows a topological diagram of a circuit of the chain-link converter in embodiment ten. In this embodiment, the power source is an AC power source, the high-frequency submodule HFSM1 comprises a half-bridge inverter circuit, the half-bridge inverter circuit comprises a switch bridge arm and a capacitor bridge arm connected in parallel, the switch bridge arm comprises two switches connected in series, and the capacitor bridge arm comprises two capacitors connected in series. The low-frequency submodules each comprises a full bridge circuit and a battery connected in parallel.

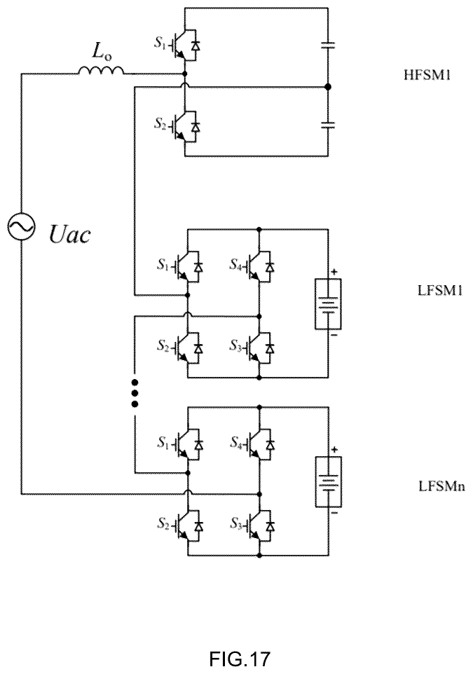

FIG. 18 shows a topological diagram of a circuit of the chain-link converter in embodiment eleven. In this embodiment, the power source is a three-phase AC power source, each phase of the three-phase chain-link converter comprises a plurality of low-frequency submodules connected in series, each low-frequency submodule comprises a full bridge circuit and an energy storage element, and the high-frequency submodule HFSM1 comprises a two-level topology. A switching time of at least one low-frequency submodule is greater than the switching time of other low-frequency submodules.

In some embodiments, the energy storage element can be a battery. The high-frequency submodule comprises three switch bridge arms and a capacitor bridge arm connected in parallel, each switch bridge arm comprises two switches connected in series, and the capacitor bridge arm comprises two capacitors connected in series.

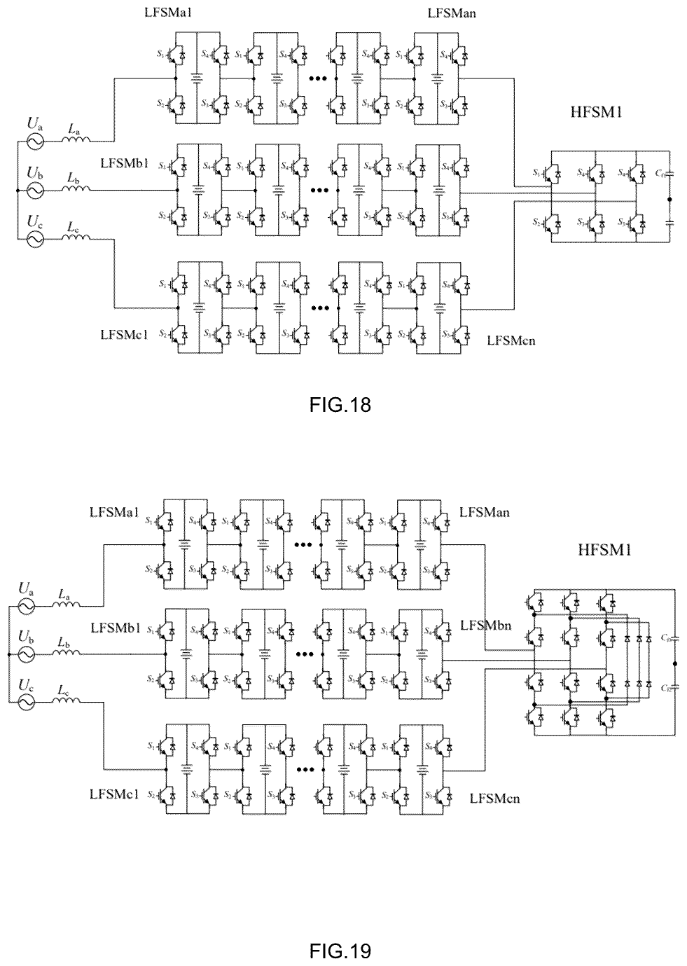

FIG. 19 shows a topological diagram of a circuit of the chain-link converter in embodiment twelve. In this embodiment, the power source is a three-phase AC power source, each phase of the three-phase chain-link converter comprises a plurality of low-frequency submodules connected in series, each low-frequency submodule comprises a full bridge circuit and an energy storage element, and the high-frequency submodule HFSM1 comprises a three-level topology. A switching time of at least one low-frequency submodule is greater than the switching time of other low-frequency submodules.

In some embodiments, the energy storage element can be a battery, and the high-frequency submodule HFSM1 comprises a central point clamped three-level topology.

Moreover, in specific implementation, the chain-link converter provided in the embodiments of the disclosure can be applied to a high-voltage based direct AC chain-link energy storage system. In the high-voltage direct AC chain-link energy storage system, a distributed capacitance to ground of the long cable between the battery cabinet and the converter will increase the common-mode current, and the distributed capacitance to ground of the battery with a huge volume also will increase the common-mode current. Therefore, the issue of the common-mode current of the high-voltage direct AC chain-link energy storage system can be effectively solved through schemes such as extending the switch time of the chain-link converter, lowering frequencies of the submodules and optimizing grounding in the disclosure.

In addition, the chain-link converter in the embodiments of the disclosure also can be applied to a MMC flexible DC system. Since the MMC system is a series architecture, influence of voltage jump of the submodules at the near ground potential point on the common-mode current is maximum, and the common-mode current can be greatly reduced by extending the switch time of a part of submodules at the near ground potential point.

It shall be noted that in the context, the terms “comprise”, “include” or any other variants intend to cover non-inclusive inclusion, such that the process, method, article or device comprising a series of factors comprises these factors, and also comprises other factors that are not clearly listed, or further comprises inherent factors of such process, method, article or device. In the case of no more limits, the factors defined by the sentence “comprising one . . . ” do not exclude additional the same factor in the process, method, article or device comprising the factor. Furthermore, it shall be indicated that the range of the method and the device in the embodiments of the disclosure is not limited to execute functions in an illustrated or discussed order, also can comprise executing functions according to the related functions in a substantial simultaneous manner or a reverse order, for example, can execute the described method in a sequence different from that described, and also can apply, omit, or combine various steps. In addition, with reference to some examples, the described features can be combined in other examples.

The embodiments of the disclosure are described above combining with the drawings, but the disclosure is not limited to the specific embodiments, the specific embodiments are only illustrative, instead of limiting, and under the inspiration of the disclosure, those ordinary in the art also can make various forms, which all within protection of the disclosure, without departing from the aim of the disclosure and the scope of protection of the claims.

What is claimed is:

1. A chain-link converter, comprising:
a first node;
a second node; and
a plurality of switch submodules, wherein the plurality of switch submodules are connected in series, and the plurality of switch submodules are electrically connected between the first node and the second node, and a switching time of at least one switch submodule is greater than the switching time of other switch submodules.

2. The chain-link converter according to claim 1, wherein the switching time of at least one switch submodule is greater than twice of the switching time of other switch submodules.

3. The chain-link converter according to claim 1, wherein the plurality of switch submodules comprise a plurality of low-frequency submodules and a first high-frequency submodule.

4. The chain-link converter according to claim 3, wherein a ground terminal is electrically connected to the second node, and one of the low-frequency submodules is electrically connected to the second node.

5. The chain-link converter according to claim 4, wherein the first high-frequency submodule is electrically connected to the first node.

6. The chain-link converter according to claim 3, wherein a distributed capacitance to ground of any of the low-frequency submodules is greater than the distributed capacitance to ground of the first high-frequency submodule.

7. The chain-link converter according to claim 3, wherein a ground terminal is electrically connected between the two adjacent low-frequency submodules.

8. The chain-link converter according to claim 7, wherein the first high-frequency submodule is electrically connected to the first node or the second node.

9. The chain-link converter according to claim 3, further comprising:
a second high-frequency submodule, the first high-frequency submodule is electrically connected to the first node, and the second high-frequency submodule is electrically connected to the second node.

10. The chain-link converter according to claim 9, wherein phases of a first port voltage of the first high-frequency submodule and a second port voltage of the second high-frequency submodule differ by 180°, such that common-mode currents of the first high-frequency submodule and the second high-frequency submodule flowing the plurality of low-frequency submodules cancel each other.

11. The chain-link converter according to claim 10, wherein the first high-frequency submodule and the second high-frequency submodule use a two-level topology or a three-level topology.

12. The chain-link converter according to claim 10, wherein the first high-frequency submodule comprises a first full bridge circuit comprising a first bridge arm and a second bridge arm connected in parallel, the first bridge arm comprises a first switch and a second switch connected in series, the second bridge arm comprises a third switch and a fourth switch connected in series, the first central point of the first bridge arm is a first jump point, the second central point of the second bridge arm is a second jump point, and a first port voltage is provided between the first jump point and the second jump point;
the second high-frequency submodule comprises a second full bridge circuit comprising a third bridge arm and a fourth bridge arm connected in parallel, the third bridge arm comprises a fifth switch and a sixth switch connected in series, the fourth bridge arm comprises a seventh switch and an eighth switch connected in series, the third central point of the third bridge arm is a third jump point, the fourth central point of the fourth bridge arm is a fourth jump point, and the second port voltage is provided between the third jump point and the fourth jump point.

13. The chain-link converter according to claim 12, wherein when the first switch and the fourth switch are turned on, the first full bridge circuit is in a first mode; when the first switch and the third switch are turned on, the first full bridge circuit is in a second mode; when the second switch and the third switch are turned on, the first full bridge circuit is in a third mode; when the second switch and the fourth switch are turned on, the first full bridge circuit is in a fourth mode;
when the fifth switch and the eighth switch are turned on, the second full bridge circuit is in the first mode; when the fifth switch and the seventh switch are turned on, the second full bridge circuit is in the second mode; when the sixth switch and the seventh switch are turned on, the second full bridge circuit is in the third mode; when the sixth switch and the eighth switch are turned on, the second full bridge circuit is in the fourth mode.

14. The chain-link converter according to claim 13, wherein when the first full bridge circuit is switched from the fourth mode to the first mode, the potential at the first jump point becomes high, and when the second full bridge circuit is switched from the first mode to the second mode, the potential at the fourth jump point becomes high;
when the first full bridge circuit is switched from the first mode to the second mode, the potential at the second jump point becomes high, and when the second full bridge circuit is switched from the fourth mode to the first mode, the potential at the third jump point becomes high;
when the first full bridge circuit is switched from the second mode to the third mode, the potential at the first jump point becomes low, and when the second full bridge circuit is switched from the third mode to the fourth mode, the potential at the fourth jump point becomes low;
when the first full bridge circuit is switched from the third mode to the fourth mode, the potential at the second jump point becomes low, and when the second full bridge circuit is switched from the second mode to the third mode, the potential at the third jump point becomes low.

15. The chain-link converter according to claim 10, wherein the first high-frequency submodule comprises a first full bridge circuit comprising a first upper bridge arm and a first lower bridge arm connected in series, a first energy storage element and a second energy storage element, the first upper bridge arm comprises a first switch and a second switch connected in series, the first lower bridge arm comprises a third switch and a fourth switch connected in series, and the first central point between the first upper bridge arm and the first lower bridge arm is a first jump point; the first full bridge circuit further comprises a first diode and a second diode connected in series between a first node and a second node, wherein the first node is arranged between the first switch and the second switch of the first upper bridge arm, and the second node is arranged between the third switch and the fourth switch of the first lower bridge arm, and a second central point between the first diode and the second diode is a second jump point; both ends of the first energy storage element and the second energy storage element after series connection are connected in parallel to the first full bridge circuit, and the third node between the first energy storage element and the second energy storage element is connected to the second central point; a first port voltage is provided between the first jump point and the second jump point;
the second high-frequency submodule comprises a second full bridge circuit comprising a second upper bridge arm and a second lower bridge arm connected in series, a third energy storage element and a fourth energy storage element, the second upper bridge arm comprises a fifth switch and a sixth switch connected in series, the second lower bridge arm comprises a seventh switch and an eighth switch connected in series, and the third central point between the second upper bridge arm and the second lower bridge arm is a third jump point; the second full bridge circuit further comprises a third diode and a fourth diode connected in series between a fourth node and a fifth node, wherein the fourth node is arranged between the fifth switch and the sixth switch of the second upper bridge arm, and the fifth node is arranged between the seventh switch and the eighth switch of the second lower bridge arm, and a fourth central point between the third diode and the fourth diode is a fourth jump point; both ends of the third energy storage element and the fourth energy storage element after series connection are connected in parallel to the second full bridge circuit, and the sixth node between the third energy storage element and the fourth energy storage element is connected to the fourth central point; the third jump point and the fourth jump point have the second port voltage therebetween.

16. The chain-link converter according to claim 3, wherein the switching time of at least one low-frequency submodule is greater than the switching time of other low-frequency submodules.

17. The chain-link converter according to claim 3, further comprising a power source or a load electrically connected between the first node and the second node.

18. The chain-link converter according to claim 17, wherein the power source is a DC power source or an AC power source, the first high-frequency submodule comprises a first switch circuit and a first energy storage element connected in parallel, and the low-frequency submodules comprise a second switch circuit and a second energy storage element connected in parallel.

19. The chain-link converter according to claim 18, wherein the first switch circuit comprises a half-bridge inverter circuit or full bridge circuit.

20. The chain-link converter according to claim 18, wherein when the power source is the DC power source, the second switch circuit comprises a half-bridge circuit or full bridge circuit.

21. The chain-link converter according to claim 18, wherein when the power source is the AC power source, the second switch circuit comprises a full bridge circuit.

22. A three-phase chain-link converter, comprising:
a three-phase source;
a high-frequency submodule; and
a plurality of low-frequency submodules, wherein each phase of the three-phase chain-link converter comprises the plurality of low-frequency submodules connected in series, three phases of the three-phase chain-link converter share the same high-frequency submodule, and a switching time of at least one low-frequency submodule is greater than the switching time of other low-frequency submodules.

23. The three-phase chain-link converter according to claim 22, wherein the high-frequency submodule comprises a two-level topology or a three-level topology.

24. The three-phase chain-link converter according to claim 22, wherein the low-frequency submodules comprise a full bridge circuit and energy storage elements connected in parallel.
